(19) United States
(12) Patent Application Publication
(10) Pub. No.: US 2007/0218429 A1
(43) Pub. Date: Sep. 20, 2007

(54) System and method for determining personal genealogical relationships and geographical origins

(76) Inventors: Brian A. Kolo, Centreville, VA (US); Jeff A. Chapman, Leesburg, VA (US); Ahmed Qureshi, Ashburn, VA (US)

Correspondence Address: Brian A. Kolo;Suite 350, 8260 Greensboro Dr., McLean, VA, 22102, US

(21) Appl. No.: 11/516,766

(22) Filed: Sep. 7, 2006

Related U.S. Application Data
(60) Provisional application No. 60/714,368, filed on Sep. 7, 2005.

(51) Int. Cl. G09B 19/00

(52) U.S. Cl. 434/154

(57) ABSTRACT

The present invention is directed toward identifying potential genealogical relationships between a plurality of individuals through name analysis. Additionally, the geographical origins of a single individual may be determined through name analysis.

### BACKGROUND OF THE INVENTION

In some cultures an individuals name is deeply connected with genealogical history. In these cultures it is common for parents to give a child only a single name. We will refer to this as the child's given name. The child may have several other names, but these names are predetermined by the child's genealogy.

For instance, in the Arab culture, it is common for parents to provide a child with a single given name. The child will have other names derived from the child's paternal genealogy. In this case, the child's second name is the same as the child's father's given name. The child's third name is the same as the child's paternal grandfather's given name. The child may have a fourth name which is the child's paternal grandfather's father's given name. This may continue as far back as the child is able to determine it's paternal genealogy.

As another example, many Hispanic persons are named using maternal genealogy. This naming convention is similar to that of the Arab culture discussed above. The main difference is instead of tracing paternal genealogy, this naming convention uses maternal genealogy. Other cultures, such as Russian, incorporate genealogy into names in similar ways.

### BRIEF SUMMARY OF THE INVENTION

The present invention is directed toward the detection of genealogical relations among individuals based upon the names of the individuals under study.

The present invention is also directed to software used to automate a genealogical study of individuals using names as part of the input to the software.

The present invention is also directed to the detection of terrorists and relatives of terrorists using genealogical information found in the terrorists name.

The present invention is also directed to the prevention of terrorism by locating and identifying terrorists before they are able to.

The present invention is also directed to the determining the city of origin or clan of people of interest.

The present invention is also directed toward determining parent-child relationships provided only the name of a parent.

### BRIEF DESCRIPTION OF THE DRAWINGS

FIG. 1a shows an example of an Arabic name and specifically identifies each sub-name of the name.

FIG. 1b shows an example of an Arabic name equivalent to the name in FIG. 1a.

FIG. 1c shows an example of an Arabic name equivalent to the name in FIG. 1a.

FIG. 1d shows an example of an Arabic name equivalent to the name in FIG. 1a.

FIG. 1e shows an example of an Arabic name equivalent to the name in FIG. 1a.

FIG. 1f shows an example of an Arabic name equivalent to the name in FIG. 1a.

FIG. 1g shows an example of an Arabic name equivalent to the name in FIG. 1a.

FIG. 2a shows an example of an Arabic name including a kunya indicating a first born son.

FIG. 2b shows an example of an Arabic name equivalent to the name in FIG. 2a.

FIG. 2c shows an example of an Arabic name equivalent to the name in FIG. 2a.

FIG. 2d shows an example of an Arabic name equivalent to the name in FIG. 2a.

FIG. 2e shows an example of an Arabic name equivalent to the name in FIG. 2a.

FIG. 3 first shows an Arabic name and follows with several names with genealogical connections to the first name, specifically showing names of a brother.

FIG. 4 first shows an Arabic name and follows with several names with genealogical connections to the first name, specifically showing names of a paternal first cousin.

FIG. 5a provides an example of a man's name and a genealogical interpretation of the name including clan and city of origin.

FIG. 5b provides an example of a woman's name and a genealogical interpretation of the name including clan and city of origin.

FIG. 6 shows a method of identifying relationships between two people.

FIG. 7 details the process of determining a genealogical relationship between two people.

FIG. 8 shows a flowchart of another method of determining a genealogical relationship between two people without using the ordering of the sub-names.

FIG. 9a illustrates a possible test and example name of siblings and identifies the matching sub-names.

FIG. 9b illustrates a possible test and example name of first cousins and identifies the matching sub-names.

FIG. 9c illustrates a possible test and example name of a grandfather and grandson and identifies the matching sub-names.

FIG. 10 diagrams a computer system setup that can be used for implementing a software program to automate genealogical matching.

### DETAILED DESCRIPTION OF THE INVENTION

Arabs often use a naming convention that incorporates paternal genealogy. A parent chooses only one name for a child. This is the child's given name. The rest of the child's name is predetermined by the genealogy of the father. The child's second name will the father's given name. The child's third name will the given name of the father's father. The fourth name will be the father's father's father's given name. This process is carried out as far as the paternal genealogy is known. Thus, a child may have twenty or more names added to the given name.

In addiction, a clan and/or city name may be added. These names appear at the end of the genealogy names. These names may or may not start with the definite article transliterated into English from Arabic as ‘el-’ or ‘al-’ as part of their tribe, sub-tribe or clan name. These definite articles may also be attached to first names of any member in ones' naming convention but not typically the first given name.

Since an individual may have twenty or more names, it is common for an individual to choose a subset of these names to refer to themselves. Commonly an individual will use their given name and some of their genealogical names and will maintain their genealogical order. However, it is also common for a person to choose to skip generations in their name. This is often the case when a particular person in the genealogy earned great respect. For instance, if a person named Osama had a grandfather who befriended a king, he may choose to be known as Osama Laden rather than Osama Mohamed Laden.

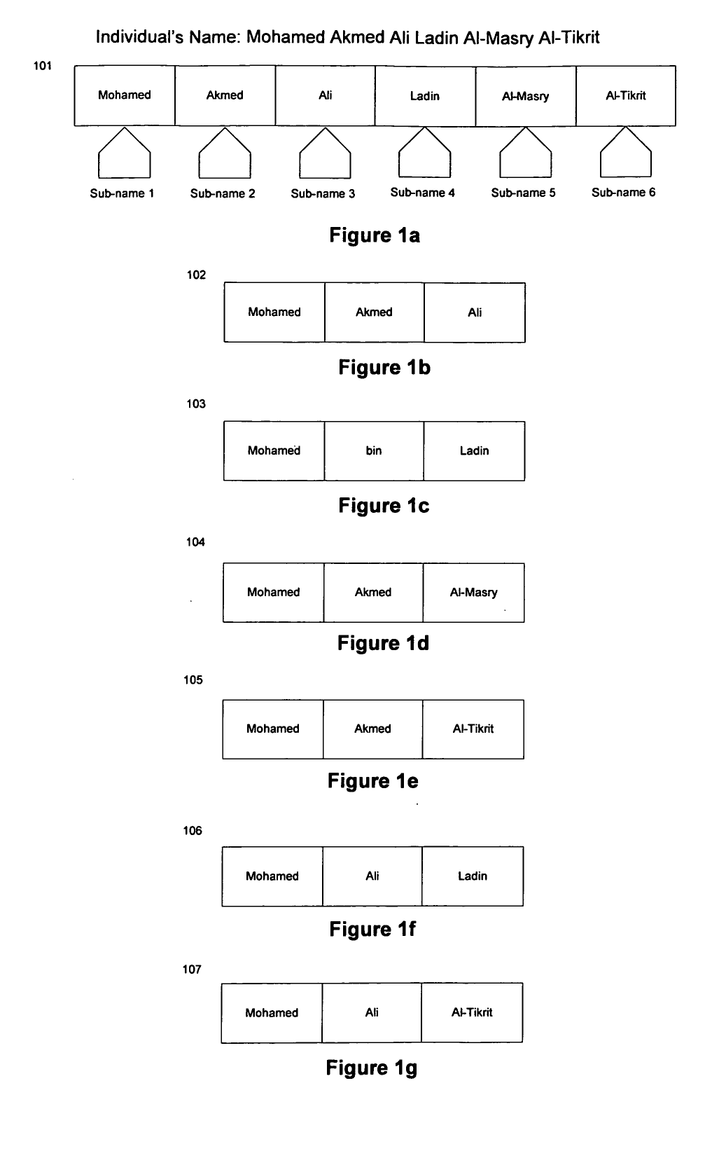

FIG. 1a provides an example of an Arabic name. An individuals name may have several parts. Each part is also a name, and theses individual parts will be referred to a sub-names. The sub-names for the name Mohamed Akmed Ali Ladin Al-Masry Al-Tikrit is shown in FIG. 1a. The sub-names are all separated by a space, and in this case are Mohamed, Akmed, Ali, Ladin, Al-Masry, and Al-Tikrit.

On interesting aspect of the Arabic naming convention is an individual may refer to themselves by using any of a large combination of sub-names. FIG. 1b provides an example of a name that might be used by the person in FIG. 1a. In this case, this person has chosen to use the first three names. This person may do so as long as they maintain the order of the names.

In addition, as shown in FIG. 1c, the Arabic naming convention allows addition of some terms into a name. In this case, the term ‘bin’ is added between Mohamed and Ladin. The term ‘bin’ indicates that Mohamed descends from a individual named Ladin. Although this is often used to indicate that Mohamed is the son of Ladin, a father-son relationship is not necessary. Ladin may be Mohamed's father, grandfather, great-grandfather, etc.

However, ‘bin’ is not the only term that can be inserted. ‘bin’, ‘ibn’, ‘ould’, and ‘bint’ all indicate a type of relationship. ‘bin’, ‘ibn’, and ‘ould’ are used to indicate a father-son relationship, while ‘bint’ indicates a father-daughter relationship. Thus, a name such as Mohameda bint Laden indicates Mohameda is a female descendant of Ladin. Again, Ladin may be Mohameda's father, grandfather, great-grandfather, etc.

FIG. 1d provides another example of a name that might be used by the individual named in FIG. 1a. In this example the individual has adopted the name Mohamed Akmed Al-Massy. Another equivalent name would be Mohamed bin Akmed Al-Massy. These two names are effectively the same and are both available to the individual names in FIG. 1a.

FIG. 1e provides another example of a name that might be used by the individual named in FIG. 1a. In this case the person has adopted a given name, his fathers given name, and the city name Al-Tikrit. This city name indicates this person is from the city of Tikrit.

FIG. 1f shows an example of skipping generations. This person uses his given name and the names of his grandfather and great-grandfather. Again, which names a person chooses to use is entirely at his or her discretion. Typically a person will use his given names and some genealogical name.

FIG. 1g provides a final example of a name the individual of FIG. 1a may choose to use. This individual uses his given name, his grandfather's name, and his city name.

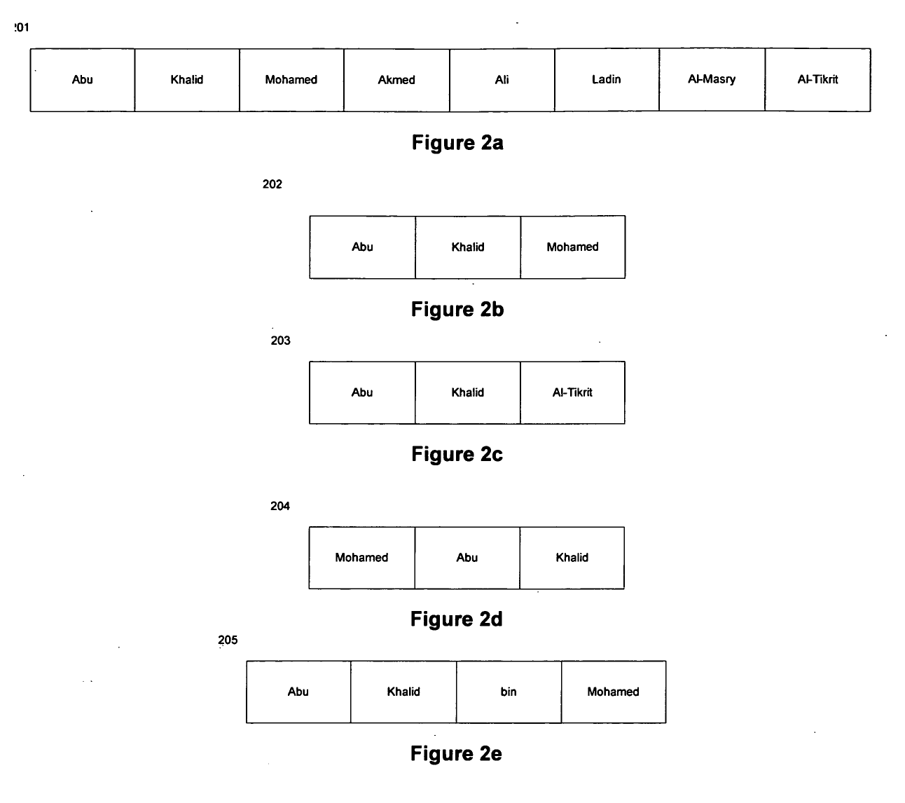

When a person has a first born son or daughter, they may adopt a kunya to their name. The kunya expresses they are a parent and adds the name of their child to the parent's name. As an example, if the individual from FIG. 1a were to have a son named Khalid, they may add Abu Khalid to the beginning of their name. This name would take the place of their first given name on a day to day basis but would not eliminate their first given name they were given at birth. Their new name is shown in FIG. 2a.

FIGS. 2b-e shows various names this person may now use including the kunya. Particular attention is drawn to the name shown in FIG. 2d. Here the kunya appears after the person's given name.

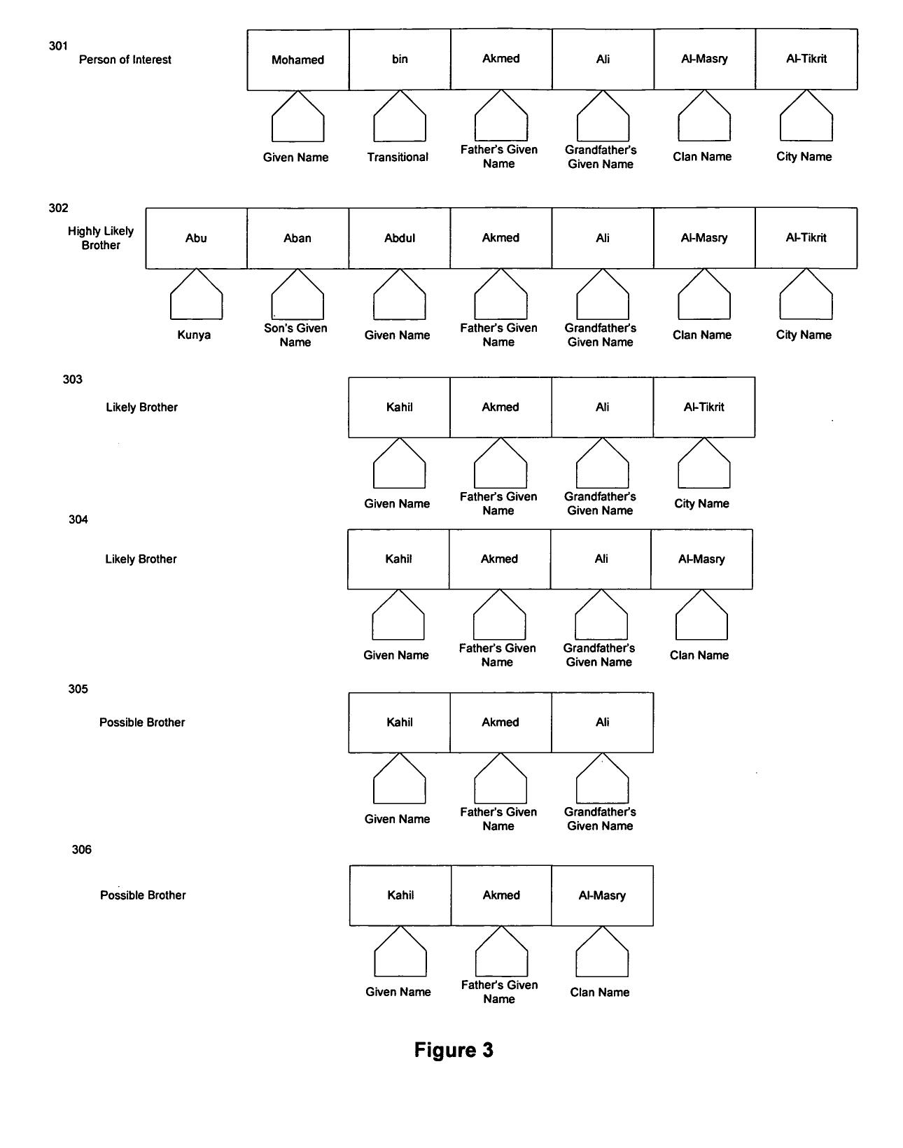

FIG. 3 begins with an individual's name explicitly showing the given name, names of the father and grandfather, a transitional, and a clan and city name. Since a person's name carries genealogical information, this person's brother would have a very similar name. The remainder of FIG. 3 provides some possible names for a brother.

In the first example, an individual named Abu Aban Adbul Akmed Ali Al-Masry Al-Tikrit could be a name of a brother. This can be seen by comparing these two names. First, note the city name is the same, indicating these two people are form the came city. Furthermore, the both share the clan name Al-Masry. Additionally, both have the same father (Akmed) and grandfather (Ali). With this information, it is highly likely these two people are brothers.

In the second example in FIG. 3, a person named Kahil Akmed Ali Al-Tikrit is likely a brother to the person of interest. In this case it is seen that they both originate from the same city (Tikrit) and both have father's with the same name (Akmed) and grandfather's with the same name (Ali). Thus, it is likely these two individuals are brothers.

Another example of a likely brother is an individual names Kahil Akmed Ali Al-Masry. Again, these two share the same father and grandfather name. In addition, they share the same clan name (Al-Masry).

The fourth example shows a possible brother with the name Kahil Akmed Ali. Again, these two share the same father and grandfather name. However, since there we don‘t have any information about the clan or city name, we cannot be as certain as in the previous cases.

As a final example shows another possible brother named Kahil Akmed Al-Masry. In this case we see they share a clan name (Al-Masry) and a father's name (Akmed). This indicates a potential sibling relationship, but the likelihood is not as strong as the earlier cases.

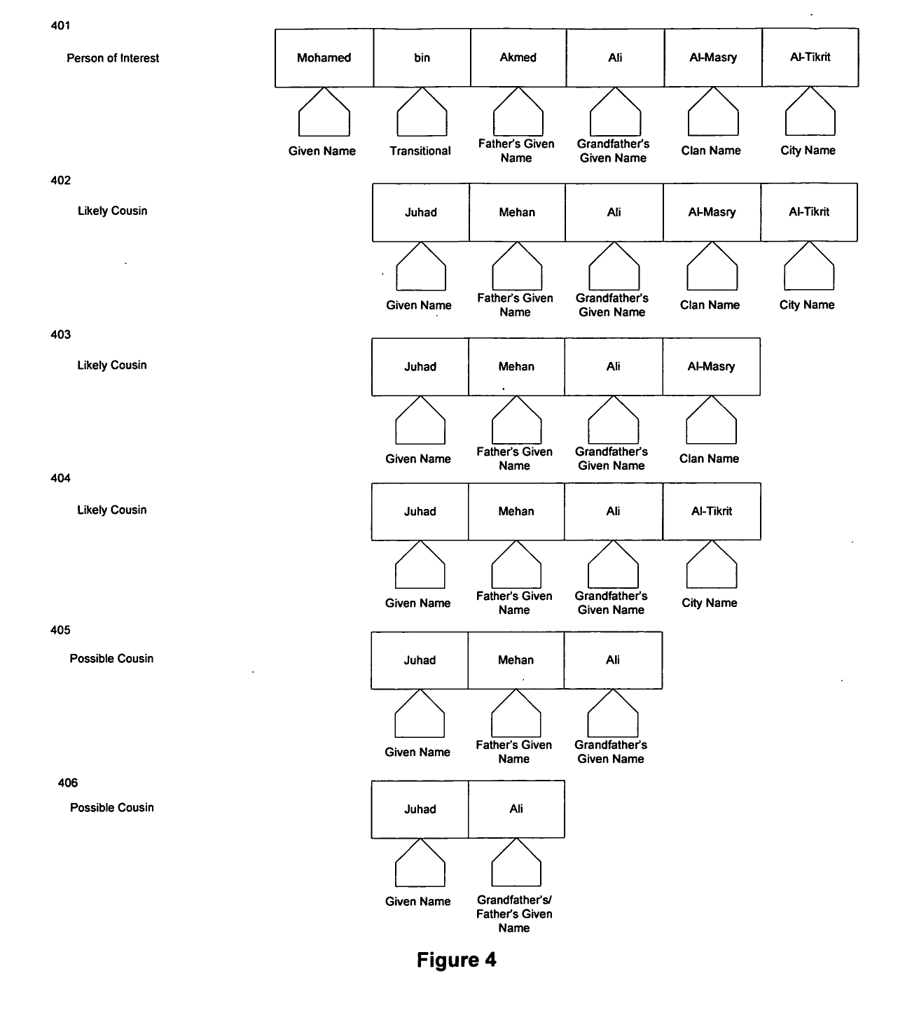

FIG. 4 provides a name of a person of interest and shows some potential names of first cousins. Again, because of the Arabic naming convention, this relationship can be discovered if these people have the same grandfather. This process is similar to that detained in FIG. 3, except rater than matching father, grandfather, clan, and city, we only match grandfather, clan, and city.

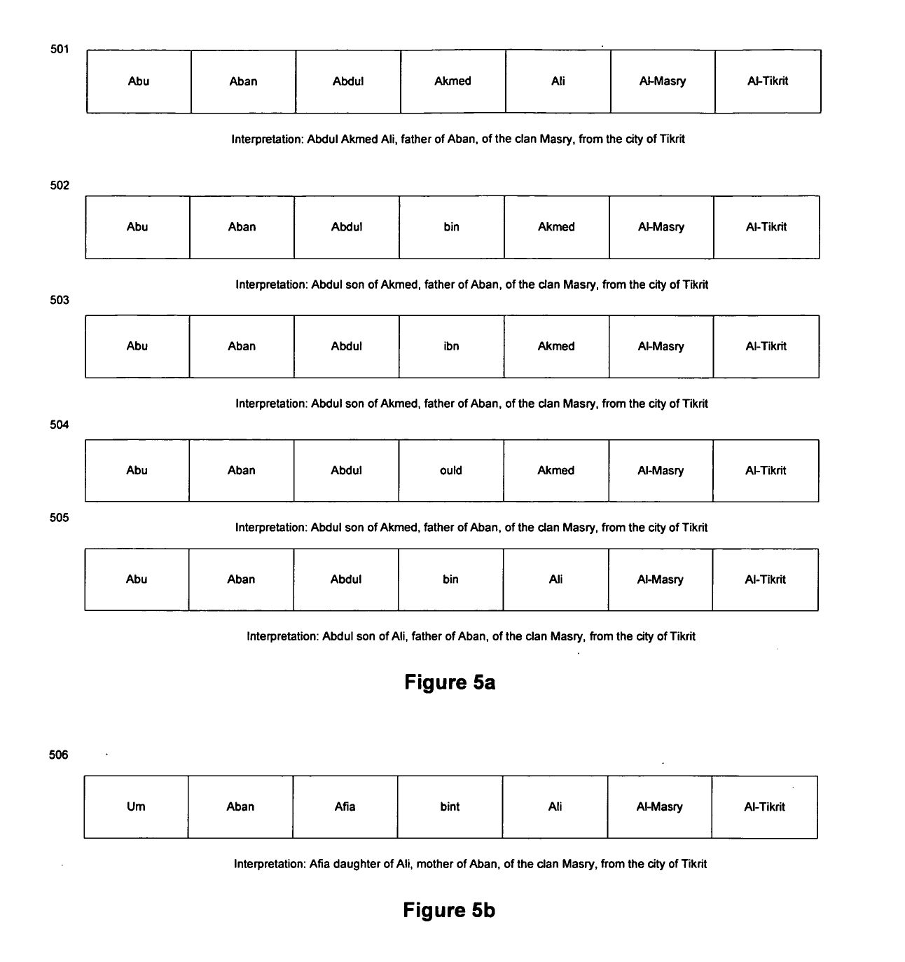

FIG. 5a shows some possible Arabic names along with an English interpretation. The first name, Abu Aban Abdul Akmed Ali Al-Masry Al-Tikrit can be interpreted as Abdul Akmed Ali, father of Aban, of the clan Masry, from the city of Tikrit.

The second name, Abu Aban Abdul bin Akmed Al-Masry Al-Tikrit can be interpreted as Abdul son of Akmed, father of Aban, of the clan Masry, from the city of Tikrit This name introduces the transitional ‘bin’. The third and fourth names have the same interpretation, only they use different transitionals. The third name uses the transitional ‘ibn’ while the fourth name uses ‘ould’. Both transitionals have the same meaning as the transitional ‘bin’.

The final example in FIG. 5a shows use of a name skipping a generation. The name Abu Aban Adbul bin Ali Al-Masry Al-Tikrit can be interpreted as Abdul, son of Ali, father of Aban, of the clan Masry, from the city Tikrit. Again, the terms ‘bin’, ‘ibn’, and ‘ould’ are interpreted as ‘son of’. However, this does not necessarily indicate a direct father-son relationship. This could be grandfather-grandson, great-grandfather-great-grandson, etc.

FIG. 5b is similar to FIG. 5a, except in this case a woman's name is used. The name Um Aban Afia bint Ali Al-Masry Al-Tikrit can be interpreted as Afia, daughter of (bint) Ali, mother of (Um) Aban, of the clan Masry, from the city of Tikrit.

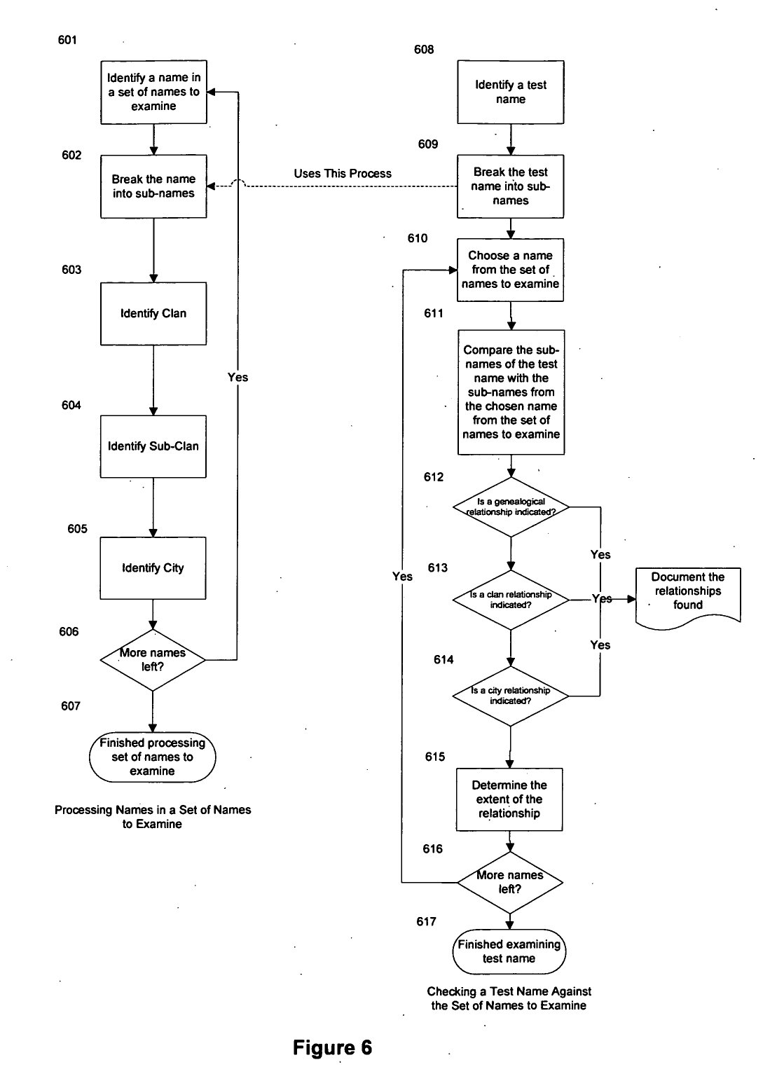

FIG. 6 is a flowchart for a method of identifying relationships between a set of people. First, a set of names is provided representing example names to check. Each of these names is broken into sub-names and a record of the names and sub-names is created. Next, a test name is provided. This test name is also broken into sub-names. The sub-names in the test name is compared to each example name. When performing this check, a genealogical comparison is made. In addition, the clan, sub-clan, and city names are compared. If any of these comparisons indicate a match, a record is made tracking the type of match found. The results are compiled and an additional step is performed which examines the extent of the relationship found. These comparisons are detailed below.

Genealogical Relationship

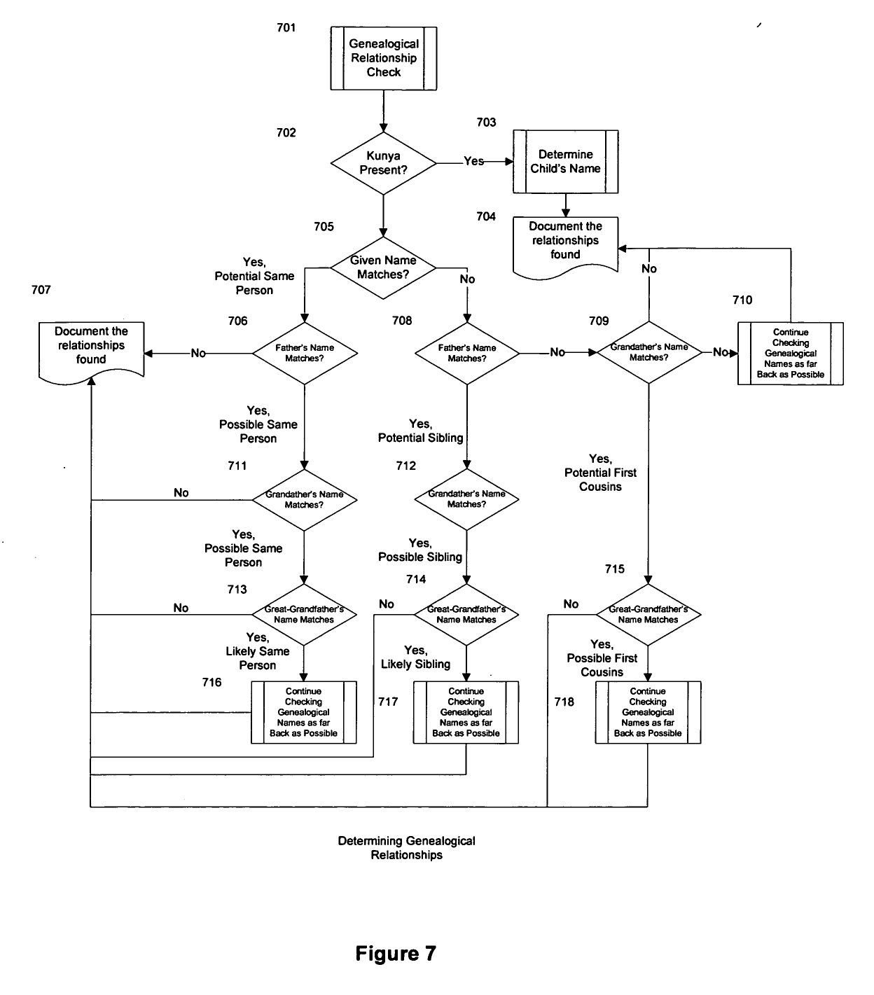

Comparing genealogies is a multiple step process and is diagrams in FIG. 7. First the kunya is located. If a kunya such as ‘Abu’ or ‘Um’ is present, if indicates a parent-child relationship. The kunya also indicates the sex of the individual because ‘Abu’ is used by fathers while ‘Um’ is used by mothers. The name following the kunya is identified as a child of the person named. From the parent name and the kunya, the child's name can be determined. If the named person is male, the child's name is the name after the kunya, followed by the parents name. If a kunya is found the child's name may be recorded for further study.

Next the first given name of the test name and the first given name of the example name is compared. If these names are the same, it is possible these two names refer to the same individual

If the first given names are the same, the father's name is compared. If these names are also the same, this is further evidence the names refer to the same individual. Each successive name is then compared. A notation is made indicating how many successive names match. If at some point one of these genealogical names differ, the names may still refer to the'same individual. In this case the individual may have used two different versions of their names. Again, a notation should be made indicating this possibility. Additionally, this may indicate the two names refer to related individuals.

If the first given names do not match, the second names are compared. If these are the same, a sibling relationship is possible. In this case the third name is checked. If these are also the same, this strengthens the chances the two names refer to siblings. Further names are then checked. The more names in common, the more likely these names refer to siblings, and a notation is made indicating the extent of the names matching. If at some point a name does not match, the names may still refer to siblings. Again, a notation is made indicating the extent of the names found to match.

If the given name and father's name do no match, the grandfather's name should be checked. If these match, the named individuals may be first cousins. Just as in the previous cases, further study of successive matching names strengthens the likelihood of a first cousin relationship.

This process continues checking successive names. If the sub-names of the two names match at some point, a potential relationship is indicated. Any potential relationship is noted.

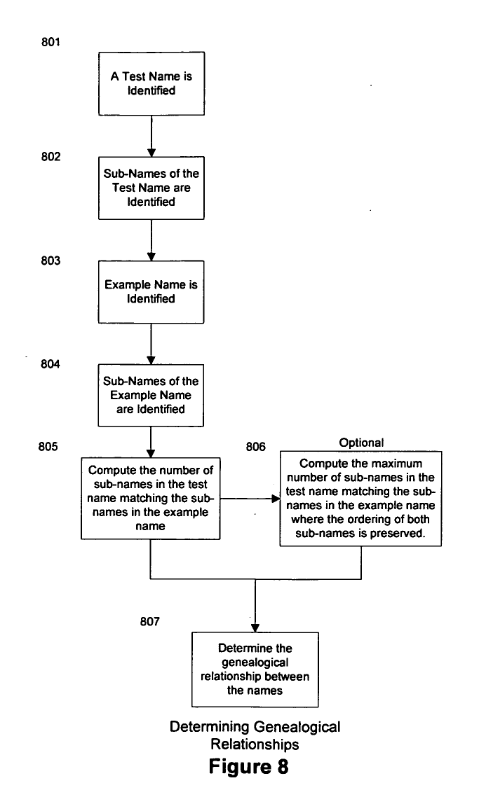

Another possible process for determining genealogical relationship is show in FIG. 8. First the sub-names of the test and example names are identified. Next, the number of sub-names common to both the test name and example name are computed. If a significant portion of these names have common sub-names, a genealogical relationship is indicated.

An optional step in this process is to identify the maximum number of sub-names the two names have in common preserving the ordering of sub-names. For instance, the names Mohamed Akmed Ali and Kahlid Ali Akmed have two sub-names in common, but only have one sub-name in common when the ordering of the sub-names must be preserved. When the ordering is preserved, the likelihood of a genealogical relationship is increased. However, in data collection, it is not uncommon for the sub-names to be reversed. Thus, this step is considered optional.

Finally, once a set of common sub-names has been identified, either through the process of matching sub-names or by the optional process of matching sub-names while preserving order, the genealogical relationship is estimated. If the optional process is used, the first sub-name common to both the test name and example name is examined. The location of this sub-name within the test name and example name indicates the type of genealogical relationship.

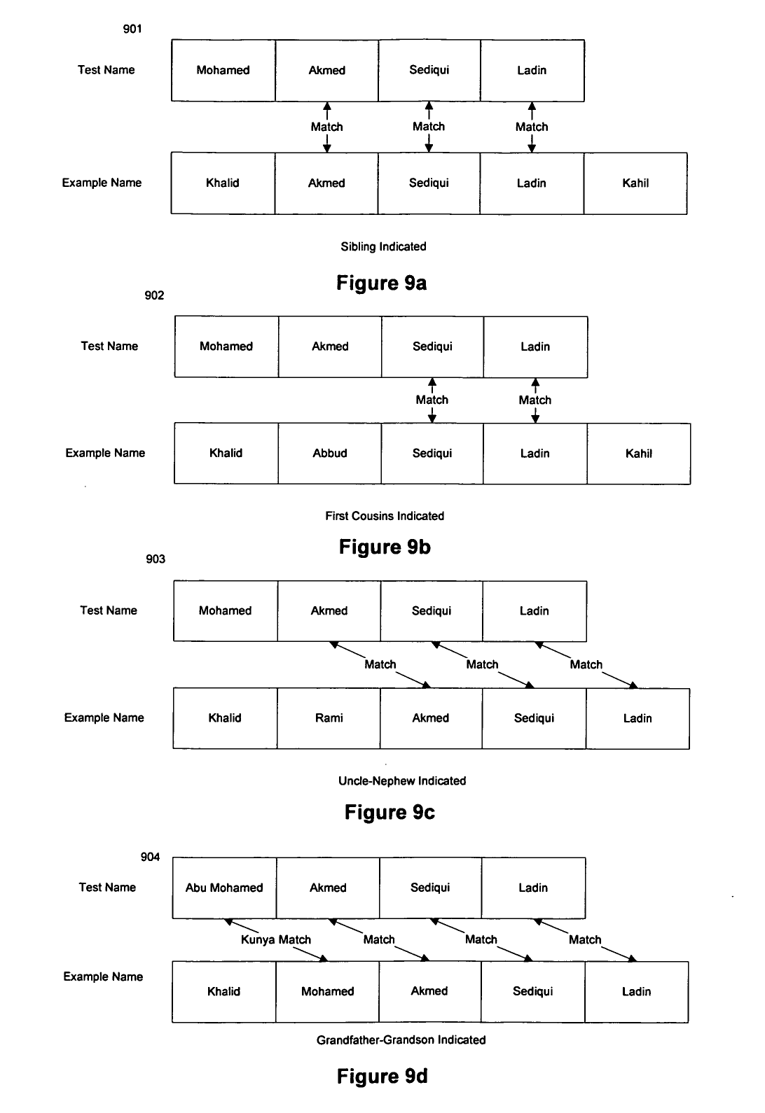

FIGS. 9a-d shows some possible relationships. In FIG. 9a, four sub-names match in order. The first matched sub-name is Akmed. This appears as the father's name in both the test name and the example name. Thus, since the two names have a common father name, the two individuals must be siblings.

In FIG. 9b, the first matched sub-name is Sediqui. This is the grandfather's name in both the test and example name. This indicates the two individuals have the same grandfather, but different father's. In this case the two individuals are first cousins.

In FIG. 9c, the first matched name is Akmed. This corresponds to the father's name in the test name and the grandfather's name in the example name. This indicates the test name is an uncle of the example name.

In FIG. 9d, the first matched name is Mohamed. Here, Mohamed appears as a kunya of the test name. Thus, Mohamed is the son of the test individual. This matches the father's name in the example name. This indicates that the son of the test name is father to the example name. This is a grandfather-grandson relationship.

In the case where the optional step is not used, a similar process is carried out. Each matching sub-name is checked. The location of each matched sub-name is found on the test name and example name. The relationship is computed as indicated in FIGS. 9a-d. This process is carried out for each matched sub-name and a list of possible relationships is determined.

If no names match, it is unlikely the two individuals have a genealogical relationship.

Clan Relationship

The sub-names are examined an a clan name is identified if present. The clan name can be identified by comparing the sub-name with known clan names. In addition, a clan name may be identified by external sources an associated with this name. For instance, if it is known that this individual belongs to a specific clan, that clan name may be associated with this name even though the clan name does not appear as one of the sub-names.

When comparing two names, a check is made if the names indicate they belong to the same clan.

Sub-Clan Relationship

The sub-names are examined and a sub-clan name is identified if present The sub-clan name can be identified by comparing the sub-name with known sub-clan names. In addition, a sub-clan name may be identified by external sources an associated with this name. For instance, if it is known that this individual belongs to a specific sub-clan, that sub-clan name may be associated with this name even though the sub-clan name does not appear as one of the sub-names.

When comparing two names, a check is made if the names indicate they belong to the same sub-clan.

City, Region, or State Relationship

The sub-names are examined and a city, region, or state name is identified if present. The geographical name can be identified by comparing the sub-name with known geographical names. In addition, a geographical name may be identified by external sources an associated with this name. For instance, if it is known that this individual belongs to a specific geographical region, that region name may be associated with this name even though the region name does not appear as one of the sub-names.

When comparing two names, a check is made if the names indicate they belong to the same region.

Extent of the Relationship

The extent of the relationship between the two named individuals is indicated by examining the results of these checks. For instance, if two individuals share a common father and grandfather name, and the two have the same clan, sub-clan, and geographical name, it is very likely the two named individuals are siblings.

In addition, a probability of a genealogical relationship may be computed. First a study is done estimating the relative frequency of a specific name in a population. This might be worldwide, by clan, by sub-clan, by geographical region, or by some combination of worldwide, clan, sub-clan and geographical region. Next, the population of each group (worldwide, clan, sub-clan, and city) is estimated. From this, one can compute the probability two individuals share sub-names.

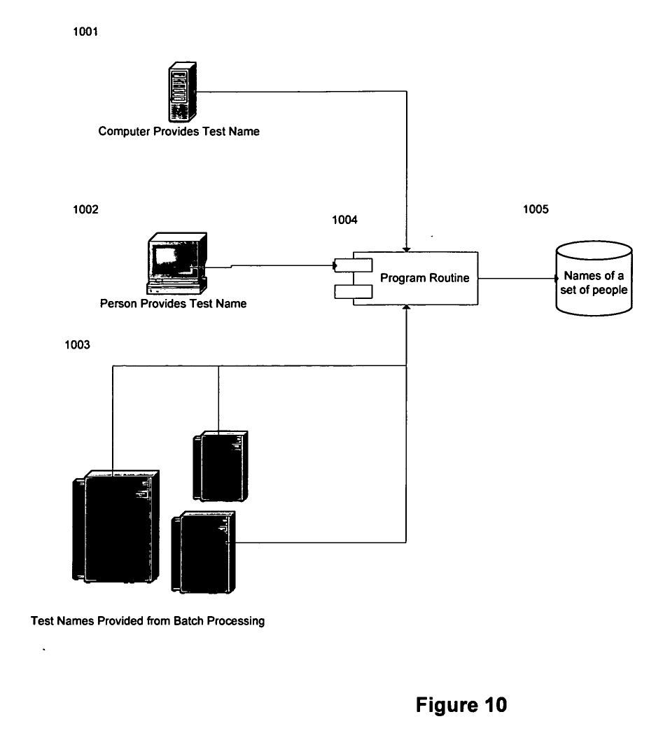

This process is readily carried out by a computer system. A potential system is shown in FIG. 10. A group of example names is provided as a dataset. This dataset may be kept as a database, text file(s), in memory, on a hard drive, DVD, CD, floppy disk, or any other computer readable media. A test name is provided to a program routine for analysis. This test name may be one of the example names, or it may be any other name of interest. The test name may be entered from a computer, a person operating a computer, a batch computing process, or any other means of entry to a program routine,

The program routine is stored on computer readable media and is able to parse a name into sub-names and compare the sub-names of the test name with the sub-names of the example names and determine possible relationships. The program may work on a single name to determine clan, sub-clan, and city names as well as discovering a kunya. If a kunya is discovered, the program routine may be used to compute a child's name solely from the parents name.

The program routine may be developed to automate the process of discovering relationships. The routine implements the methods diagrams in FIGS. 7 and/or 8. The routine can thus determine potential relationships given the names of two individuals.

The program routine is not limited to a single process but may be a group of programs running independently or in conjunction. The routine could be run as a single process on a single computer or could be run as multiple processes on many computers. The routine could also be run in a parallel mode to enhance performance. The routine may also utilize multiple processors in a single computer or across a plurality of computers.

The invention is not limited to the embodiments described above but should be construed to encompass alternative designs and implementations. For instance, the process of computing the sub-names of the example individuals may be completed while examining the test name or could be completed in advance. The computer system could be a single computer, a plurality of computers, utilize the World Wide Web, or a peer-to-peer network.

Topological Tokens

Topological Tokens may enhance the analysis of the names of the test individual and/or the set of people under examination. A topological token may be used to match two names that are spelled differently.

We claim:

1. A method of identifying relationships between a plurality of people, the method comprising the steps of:
examining the names of a set of people by identifying the name of each person in the set of people; and
for each person in the set of people, identifying the subnames of the person; and
examining the name of a test individual by identifying each of the test individuals subnames; and
comprising the subnames of the test individual with the subnames of each person in the set of people to determine the relationships between the test individual and each person of the set of individuals.

2. The method of claim 1, wherein the relationship determined is a genealogical relationship.

3. The method of claim 2, wherein the genealogical relationship is capable of detecting a relationship between paternal first cousins or maternal first cousins.

4. The method of claim 2, wherein the genealogical relationship is capable of detecting a parent-child relationship when the test individual is the parent and the child is not among the set of people.

5. The method of claim 4, wherein at least one person in the set of people has at least three subnames and the test individual has at least two subnames.

6. The method of claim 4, wherein the test individual's subnames include the test individuals father's first given name.

7. The method of claim 3, wherein the test individual's subnames include the test individuals father's first given name, the test individual's grandfather's first given name, and where the test individuals father's first given name and the test individuals grandfather's first given name are different.

8. The method of claim 3, wherein the test individual's subnames include the test individuals mother's first given name.

9. The method of claim 3, wherein the test individual's subnames include the test individuals mother's first given name, the test individual's grandmother's first given name, and where the test individuals mother's first given name and the test individuals grandmother's first given name are different.

10. A software system for identifying relationships between a plurality of people, the software system comprising:
a dataset, containing in part names of a set of people; and
a name of a test individual including at least one subname; and
a program routine contained on computer readable media comprising:
a means for parsing the test individuals name into subnames,
a means for comparing the test individuals subnames with the subnames in the dataset, and
a means for determining a genealogical relationship between the test individual and each person in the dataset.

11. The method of claim 10, wherein at least one person in the set of people has at least two subnames.

12. The method of claim 10, wherein at least one person in the set of people has at least three subnames.

13. The method of claim 10, wherein at least one person in the set of people has at least four subnames.

14. The method of claim 10, wherein the means for determining a genealogical relationship includes a computation based in part on the relative frequency a name appears in a clan or geographical region.

15. The method of claim 10, wherein the test individual has at least three subnames.

16. The method of claim 10, wherein the test individual has at least four subnames.

17. The method of claim 10, wherein the relationship determined is a genealogical relationship.

18. The software system of claim 10, wherein the name of the test individual is also a member of the set of people in the dataset.

19. The software system of claim 17, wherein the means for determining a genealogical relationship includes a means for detecting a genealogical relationship between paternal first cousins or maternal first cousins.

20. The software system of claim 18, wherein the dataset is a database contained on computer readable media.

21. The software system of claim 18, wherein the test individual has at least four subnames and at least one of the set of people has at least four subnames.

22. The software system of claim 10, wherein the programming means further comprises a means for defining a test individuals place of origin.

23. The software system of claim 17, wherein the means for determining a genealogical relationship includes a means for determining the name of a child given as input only the name of a parent and where the name of the child is not a member of the dataset.

24. The software system of claim 17, wherein the means for determining a genealogical relationship includes a means for determining if the test name is the same as a name in the set of people when the test name is not identical to the name in the set of people.

25. The software system of claim 24, wherein the means for determining a genealogical relationship includes a means for detecting transliteration variants using a topological token.
